(19) United States
(12) Patent Application Publication
(10) Pub. No.: US 2015/0171776 A1
(43) Pub. Date: Jun. 18, 2015

(54) ELECTRIC VEHICLE

(71) Applicant: TOYOTA JIDOSHA KABUSHIKI KAISHA, Toyota-shi (JP)

(72) Inventor: Takashi OTA, Toyota-shi (JP)

(21) Appl. No.: 14/565,765

(22) Filed: Dec. 10, 2014

(30) Foreign Application Priority Data
Dec. 13, 2013 (JP) 2013-258200

(51) Int. Cl. H02P 5/74

(52) U.S. Cl. CPC H02P 5/74

(57) ABSTRACT

An electric vehicle including: an induction motor generator; a synchronous motor generator; an inverter that converts a supplied high voltage VH to an AC voltage to be supplied to the induction motor generator and the synchronous motor generator; and a control unit that adjusts the rotational speed and torque output of the induction motor generator and the synchronous motor generator, wherein the control unit includes a voltage oscillation reduction program for causing the induction motor generator to generate voltage oscillation in a phase opposite to voltage oscillation of the high voltage VH to reduce the voltage oscillation of the high voltage VH when the high voltage VH supplied to the inverter oscillates at an amplitude equal to or greater than a predetermined voltage value due to rotation of the synchronous motor generator. As a result, the voltage oscillation in a PCU of the electric vehicle is reduced.

### CROSS-REFERENCE TO RELATED APPLICATION

This application claims priority to Japanese Patent Application No. 2013-258200, filed on Dec. 13, 2013, which is incorporated herein by reference in its entirety.

### TECHNICAL FIELD

The present invention generally relates to a structure of an electric vehicle, and more particularly to a configuration of a control apparatus of an electric vehicle.

### BACKGROUND ART

A power control apparatus (PCU) including a boost converter that boosts the voltage of a battery as a power source and including an inverter that converts DC power boosted by the boost converter to AC power to supply the AC power to a motor for driving a vehicle is used in an electric vehicle, such as an electric car that drives a vehicle by a motor and a hybrid car that drives a vehicle by output of a motor and an engine. As for the motor for driving a vehicle, electric vehicles often include synchronous motors or include induction motors along with the synchronous motors. Examples of the electric vehicles include: an electric vehicle, in which a plurality of synchronous motors drive the front wheel, and an induction motor drives the rear wheel; and an electric vehicle, in which a synchronous motor and an induction motor drive the front wheel, and an induction motor drives the rear wheel (for example, see Japanese Patent Laid-Open Publication No. 2009-268265).

### SUMMARY OF THE INVENTION

In a synchronous motor, the rotational speed (electrical frequency) of AC power supplied to a stator coil is synchronous with the rotational speed (electrical frequency) of a rotor, and torque variation is generated at a frequency of an integral multiple of the frequency of the AC power supplied to the stator coil according to the number of poles of the rotor and the stator. The torque variation generates variation in the counter-electromotive voltage at the frequency of an integral multiple of the frequency of the supplied AC power.

When the number of oscillations of the counter-electromotive voltage approaches an electric oscillation frequency specific to a circuit of a PCU determined by a smoothing capacitor in an inverter, a coil of a boost converter, a resistor, and the like, voltage oscillation may be excited in the circuit of the PCU. For example, when the number of oscillations of the counter-electromotive force from the synchronous motor approaches an LC resonance frequency determined by an electrostatic capacitance (C) of the smoothing capacitor of the inverter and a reactance (L) of the coil of the booster converter, LC resonance in the circuit of the PCU may be excited, and the output voltage of the boost converter or the input voltage of the inverter may be significantly oscillated. Even when the PCU does not include the boost converter, the oscillation of the counter-electromotive voltage from the synchronous motor may generate voltage oscillation in the PCU circuit at a frequency determined by the electrostatic capacitance (C) of the capacitor in the circuit, a resistance (R), reactance components in the circuit, and the like.

In the synchronous motor, the rotational speed and the torque output are controlled by adjusting the voltage, the current, and the waveform to be supplied to the stator coil based on results of detection of the current supplied to the stator coil and the rotation angle of the rotor detected by a current sensor and a resolver, respectively. Therefore, when a detection error of the current sensor that detects the current supplied to the stator coil or a detection error of the resolver is greater than a predetermined value, the control stability may be reduced, and oscillation may be generated in the rotational speed and the torque output of the synchronous motor. In that case, voltage oscillation caused by the reduction in the control stability is also generated in the counter-electromotive voltage of the synchronous motor. The voltage oscillation may also be excited in the circuit of the PCU when the frequency of the voltage oscillation approaches the number of voltage oscillations specific to the circuit of the PCU.

When the voltage oscillation is generated in the circuit of the PCU, high voltage is applied to electrical elements in the circuit, such as switching elements and diodes, and there is a problem that the lifetime of the electrical elements is reduced.

It is an advantage of the present invention to reduce voltage oscillation in a PCU in an electric vehicle.

### Means for Solving the Problems

The present invention provides an electric vehicle including: at least one induction motor for driving a vehicle; at least one other motor for driving a vehicle; at least one inverter that supplies at least one AC voltage to the at least one induction motor for driving a vehicle; at least one other inverter that supplies at least one other AC voltage to the at least one other motor for driving a vehicle; and a control unit that adjusts respective rotational speed and respective torque output of the at least one induction motor for driving a vehicle and the at least one other motor for driving a vehicle, wherein the control unit includes voltage oscillation reduction means for causing the at least one induction motor for driving a vehicle to generate voltage oscillation in a phase opposite to voltage oscillation of DC voltage to reduce the voltage oscillation of the DC voltage when the DC voltage supplied to the inverters oscillates at an amplitude equal to or greater than a predetermined voltage value due to rotation of the at least one other motor for driving a vehicle.

Preferably, in the electric vehicle of the present invention, the voltage oscillation reduction means are first means for oscillating a slip frequency of the at least one induction motor for driving a vehicle at a frequency of the voltage oscillation of the DC voltage to generate the voltage oscillation in the phase opposite to the voltage oscillation of the DC voltage.

Preferably, in the electric vehicle of the present invention, the first means oscillate the slip frequency while maintaining the torque output of the at least one induction motor for driving a vehicle.

Preferably, in the electric vehicle of the present invention, the voltage oscillation reduction means are second means for supplying, to the at least one induction motor for driving a vehicle, an AC current that causes a current ripple of the at least one induction motor for driving a vehicle to generate the voltage of the phase opposite to the voltage oscillation of the DC voltage at the frequency of the voltage oscillation of the DC voltage.

Preferably, in the electric vehicle of the present invention, the second means change the slip frequency of the at least one induction motor for driving a vehicle to bring the current ripple of the at least one induction motor for driving a vehicle into line with the frequency of the voltage oscillation of the DC voltage and change the phase of the AC current to bring the phase of the current ripple of the at least one induction motor for driving a vehicle into line with the phase opposite to the voltage oscillation of the DC voltage.

Preferably, in the electric vehicle of the present invention, the second means change the slip frequency while maintaining the torque output of the at least one induction motor for driving a vehicle.

Preferably, in the electric vehicle of the present invention, the voltage oscillation reduction means include: first means for oscillating the slip frequency of the at least one induction motor for driving a vehicle at the frequency of the voltage oscillation of the DC voltage to generate the voltage oscillation in the phase opposite to the voltage oscillation of the DC voltage; and second means for supplying, to the at least one induction motor for driving a vehicle, an AC current that causes the current ripple of the at least one induction motor for driving a vehicle to generate the voltage of the phase opposite to the voltage oscillation of the DC voltage at the frequency of the voltage oscillation of the DC voltage, use the first means if the frequency of the voltage oscillation of the DC voltage is equal to or greater than a predetermined frequency, and use the second means if the frequency of the voltage oscillation of the DC voltage is smaller than the predetermined frequency.

Preferably, in the electric vehicle of the present invention, further included is a voltage sensor that detects the DC voltage supplied to the inverters, wherein the voltage oscillation reduction means are third means for changing the slip frequency of the at least one induction motor for driving a vehicle while maintaining the torque output of the at least one induction motor for driving a vehicle according to the DC voltage detected by the voltage sensor.

The present invention provides an electric vehicle including: at least one induction motor for driving a vehicle; at least one other motor for driving a vehicle; at least one inverter that supplies at least one AC voltage to the at least one induction motor for driving a vehicle; at least one other inverter that supplies at least one other AC voltage to the at least one other motor for driving a vehicle; and a control unit that includes a CPU and that adjusts respective rotational speed and respective torque output of the at least one induction motor for driving a vehicle and the at least one other motor for driving a vehicle, wherein the control unit causes the CPU to execute a voltage oscillation reduction program for causing the at least one induction motor for driving a vehicle to generate voltage oscillation in a phase opposite to voltage oscillation of DC voltage to reduce the voltage oscillation of the DC voltage when the DC voltage supplied to the inverters oscillates at an amplitude equal to or greater than a predetermined voltage value due to rotation of the at least one other motor for driving a vehicle.

The present invention provides a control method of an electric vehicle, the electric vehicle including: at least one induction motor for driving a vehicle; at least one other motor for driving a vehicle; at least one inverter that supplies at least one AC voltage to the at least one induction motor for driving a vehicle; at least one other inverter that supplies at least one other AC voltage to the at least one other motor for driving a vehicle; and a control unit that adjusts respective rotational speed and respective torque output of the at least one induction motor for driving a vehicle and the at least one other motor for driving a vehicle, the control method causing the at least one induction motor for driving a vehicle to generate voltage oscillation in a phase opposite to voltage oscillation of DC voltage to reduce the voltage oscillation of the DC voltage when the DC voltage supplied to the inverters oscillates at an amplitude equal to or greater than a predetermined voltage value due to rotation of the at least one other motor for driving a vehicle.

### Advantage of the Invention

It is an advantage of the present invention that voltage oscillation in a PCU can be reduced in an electric vehicle.

### BRIEF DESCRIPTION OF THE DRAWINGS

FIG. 1 is a block diagram showing a configuration of an electric vehicle of the present invention;

FIG. 2 shows torque of an induction motor generator used in the electric vehicle of the present invention, a slip frequency, characteristic curves of current, and control curves of the slip frequency relative to a torque command;

FIG. 3 is a flow chart showing operation of the electric vehicle of the present invention;

FIG. 4 is a view showing change in a high voltage VH in the electric vehicle of the present invention (lower graph (a)) and a frequency distribution of the high voltage VH (upper graph (b));

FIG. 5A is a graph showing change over time of the high voltage VH in the electric vehicle of the present invention in the operation described in FIG. 3;

FIG. 5B is a graph showing change over time of an induction motor torque command T* in the electric vehicle of the present invention in the operation described in FIG. 3;

FIG. 5C is a graph showing change over time of a slip frequency command S* in the electric vehicle of the present invention in the operation described in FIG. 3;

FIG. 5D is a graph showing change over time of an induction motor current command I* in the electric vehicle of the present invention in the operation described in FIG. 3;

FIG. 5E is a graph showing change over time of induction motor power consumption P_{w} in the electric vehicle of the present invention in the operation described in FIG. 3;

FIG. 6 is a flow chart showing another operation of the electric vehicle of the present invention;

FIG. 7A is a graph showing change over time of the high voltage VH in the electric vehicle of the present invention in the operation described in FIG. 6;

FIG. 7B is a graph showing change over time of the induction motor current value in the electric vehicle of the present invention in the operation described in FIG. 6;

FIG. 8 is a flow chart showing another operation of the electric vehicle of the present invention; and

FIG. 9 is a map showing a slip frequency setting value of the induction motor relative to the high voltage VH in the electric vehicle of the present invention.

### DETAILED DESCRIPTION OF THE INVENTION

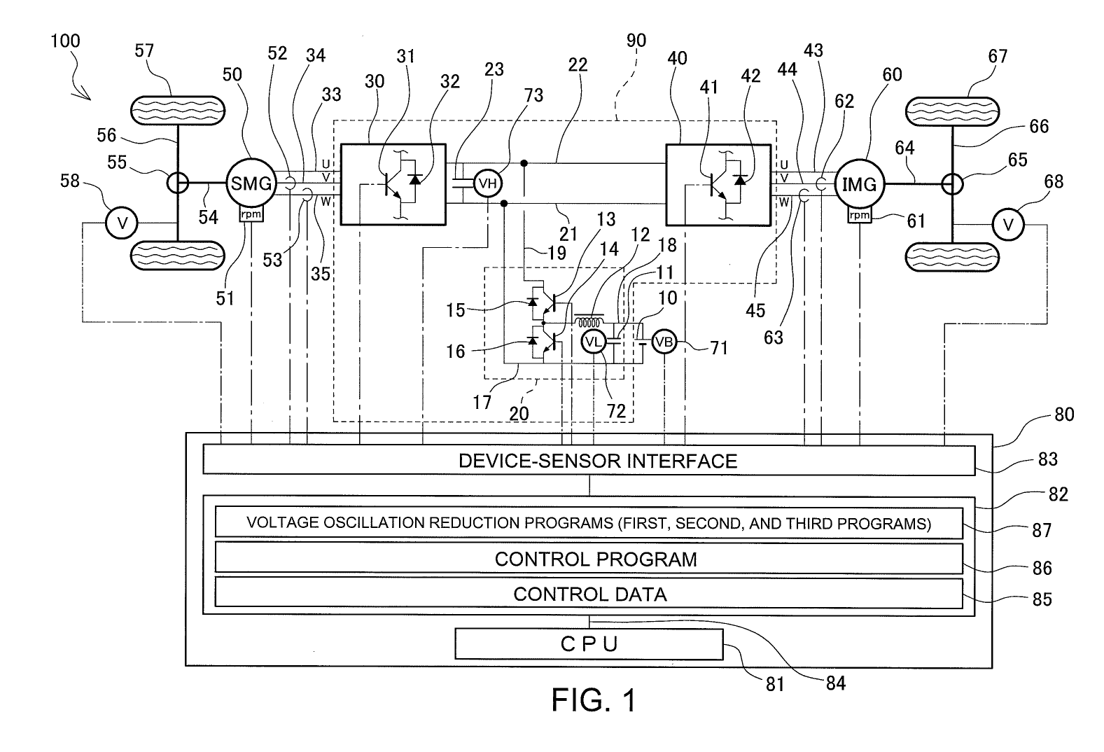

Hereinafter, embodiments of the present invention will be described with reference to the drawings. As shown in FIG. 1, an electric vehicle 100 of the present embodiment includes: a front wheel 57 driven by a synchronous motor generator 50 that is another motor for driving a vehicle; and a rear wheel 67 driven by an induction motor generator 60 that is an induction motor for driving a vehicle. The synchronous motor generator 50 may be, for example, a permanent magnet synchronous motor generator (PMSMG) including a permanent magnet incorporated into a rotor.

As shown in FIG. 1, a boost converter 20 obtains boost DC power by boosting the voltage of DC power supplied from a battery 10 that is a secondary battery that can be charged and discharged, an inverter 30 that is “another inverter” converts the boost DC power to three-phase AC power (another AC voltage), and the three-phase AC power is supplied to the synchronous motor generator 50. An inverter 40 that is an “inverter” converts DC power supplied from the common battery 10 and the boost converter 20 to three-phase AC power (AC voltage), and the three-phase AC power is supplied to the induction motor generator 60. A voltage sensor 71 that directly measures the output voltage of the battery 10 is attached to the battery 10.

The boost converter 20 includes a minus side electric circuit 17 connected to the minus side of the battery 10, a low-pressure electric circuit 18 connected to the plus side of the battery 10, and a high-pressure electric circuit 19 at the plus side output terminal of the boost converter 20. The boost converter 20 includes an upper arm switching element 13 arranged between the low-pressure electric circuit 18 and the high-pressure electric circuit 19, a lower arm switching element 14 arranged between the minus side electric circuit 17 and the low-pressure electric circuit 18, a reactor 12 arranged in series with the low-pressure electric circuit 18, a filter capacitor 11 arranged between the low-pressure electric circuit 18 and the minus side electric circuit 17, and a low-voltage sensor 72 that detects a low voltage VL of both ends of the filter capacitor 11. Diodes 15 and 16 are connected in antiparallel to the switching elements 13 and 14, respectively. The boost converter 20 turns on the lower arm switching element 14 and turns off the upper arm switching element 13 to accumulate electrical energy from the battery 10 in the reactor 12. The boost converter 20 then turns off the lower arm switching element 14 and turns on the upper arm switching element 13 to increases the voltage by the electric energy accumulated in the reactor 12. The boost converter 20 outputs the boosted voltage to the high-pressure electric circuit 19.

The inverter 30 that supplies AC power to the synchronous motor generator 50 and the inverter 40 that supplies AC power to the induction motor generator 60 include: a common high-pressure electric circuit 22 connected to the high-pressure electric circuit 19 of the boost converter 20; and a common minus side electric circuit 21 connected to the minus side electric circuit 17 of the boost converter 20. A smoothing capacitor 23 that smoothes DC current supplied from the boost converter 20 is connected between the high-pressure electric circuit 22 and the minus side electric circuit 21 between the boost converter 20 and the inverter 30. A high-voltage sensor 73 that detects the voltage at both ends of the smoothing capacitor 23 detects a boosted high voltage VH supplied to the inverters 30 and 40. Therefore, the high voltages VH supplied to the inverters 30 and 40 are the same voltages in the present embodiment.

The inverters 30 include six switching elements 31 in total for an upper arm and a lower arm in U, V, and W phases inside. Diodes 32 are connected in antiparallel to the switching elements 31 (in FIG. 1, only one of the six switching elements and one of the six diodes are illustrated, and the other switching elements and diodes are not illustrated). Output lines 33, 34, and 35 that output currents of the U, V, and W phases are attached between the switching elements of the upper arm and the switching elements of the lower arm of the U, V, and W phases of the inverter 30, respectively, and the output lines 33, 34, and 35 are connected to the input terminals of the U, V, and W phases of the synchronous motor generator 50. In the present embodiment, current sensors 52 and 53 that detect the currents are attached to the output lines 34 and 35 of the V phase and the W phase, respectively. Although a current sensor is not attached to the output line 33 of the U phase, the total of the currents of the U, V, and W phases is zero in the three-phase AC, and the current value of the U phase can be obtained by calculation from the current values of the V phase and the W phase.

An output axis 54 of the synchronous motor generator 50 is connected to a drive mechanism 55, such as a differential gear and a reduction gear, and the drive mechanism 55 converts the torque output of the synchronous motor generator 50 to drive torque of a front axle 56 to drive the front wheel 57. A vehicle speed sensor 58 that detects the vehicle speed from the rotation speed of the axle 56 is attached to the axle 56. A resolver 51 that detects the rotation angle or the rotational speed of the rotor is attached to the synchronous motor generator 50.

As in the synchronous motor generator 50, the inverter 40 converts the high voltage VH boosted by the boost converter 20 to three-phase AC power, and the three-phase AC power is supplied to the induction motor generator 60. Configurations of the inverter 40 (switching element 41 and diode 42), current sensors 62 and 63, and a resolver 61 are the same as the inverter 30, the current sensors 52 and 53, and the resolver 51 used to drive the synchronous motor generator 50 described above. Like the output axis 54 of the synchronous motor generator 50, an output axis 64 of the induction motor generator 60 is connected to a drive mechanism 65, such as a differential gear and a reduction gear, and the drive mechanism 65 is connected to a rear axle 66 to drive the rear wheel 67. A vehicle speed sensor 68 is attached to the axle 66, as with the axle 56. The boost converter 20, the smoothing capacitor 23, and the inverters 30 and 40 form a PCU 90.

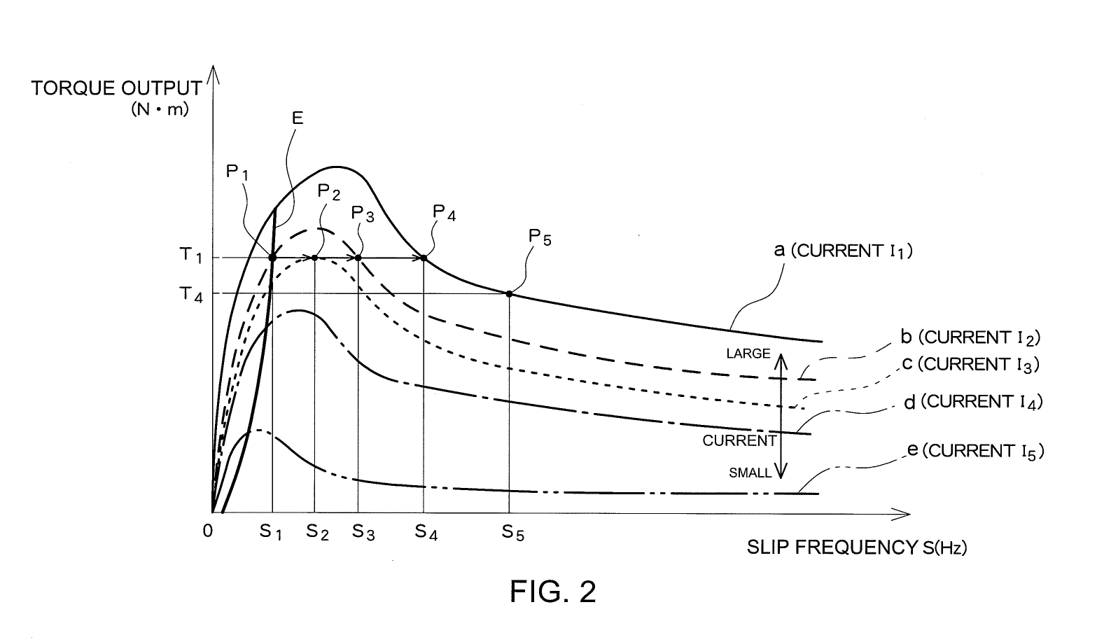

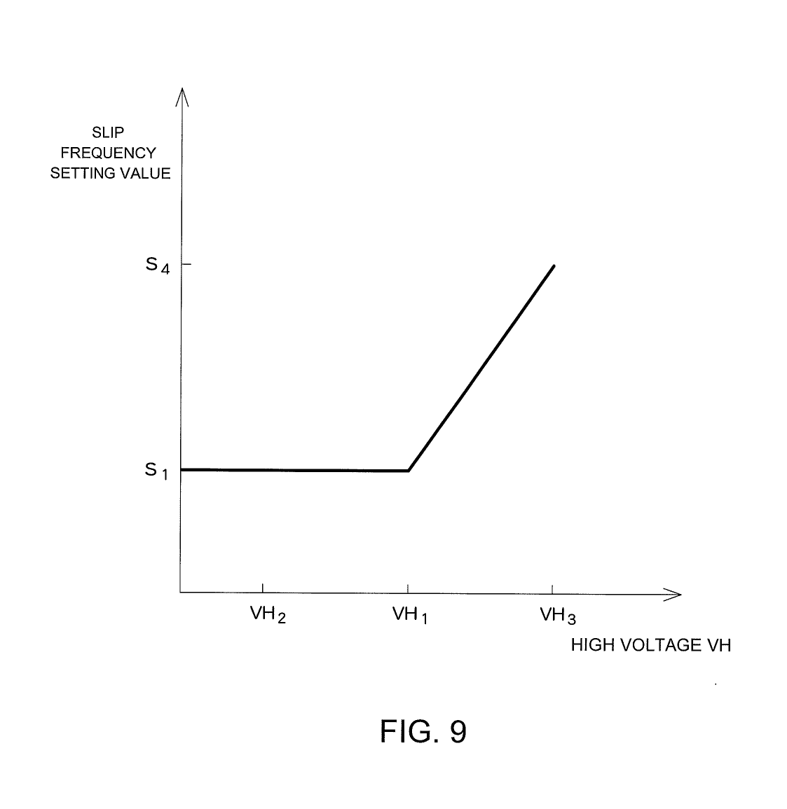

As shown in FIG. 1, a control unit 80 includes a CPU 81 that executes arithmetic and information processing, a storage unit 82, and a device-sensor interface 83, and the CPU 81, the storage unit 82, and the device-sensor interface 83 are computers connected by a data bus 84. Control data 85 of the electric vehicle 100, a control program 86, and voltage oscillation reduction programs 87 described later (including first, second, and third programs) are stored in the storage unit 82. The voltage oscillation reduction programs 87 (including the first, second, and third programs) are provided with a map that defines slip frequency setting values relative to the high voltage VH shown in FIG. 9. An optimal efficiency line E and characteristic curves a to e of the induction motor generator 60 shown in FIG. 2 described later are stored in the control data 85. The switching elements 13 and 14 of the boost converter 20 and the switching elements 31 and 41 of the inverters 30 and 40 described above are connected to the control unit 80 through the device-sensor interface 83, and the switching elements are operated by commands of the control unit 80. The output of the sensors including the voltage sensor 71, the low-voltage sensor 72, the high-voltage sensor 73, the current sensors 52, 53, 62, and 63, the resolvers 51 and 61, and the vehicle speed sensors 58 and 68 are input to the control unit 80 through the device-sensor interface 83.

Before describing the operation of the electric vehicle 100 configured as described above, the torque output characteristics relative to a slip frequency S and control of the induction motor generator 60 mounted on the electric vehicle 100 will be described with reference to FIG. 2.

A solid line a, a broken line b, a dotted line c, an alternate long and short dash line d, and an alternate long and two short dashes line e of FIG. 2 are characteristic curves showing relationships between the torque output and the slip frequency S with currents I₁, I₂, I₃, I₄, and I₅ (I₁>I₂>I₃>I₄>I₅) supplied to the induction motor generator 60, respectively. The solid line a of FIG. 2 is a characteristic curve when the current I₁ flowing through the stator coil is the maximum current. As indicated by the lines a to e of FIG. 2, the torque output of the induction motor generator 60 is zero when the slip frequency S is zero, that is, when the difference between an electrical frequency [Hz] of the rotor caused by the rotation of the rotor and an electrical frequency [Hz] of the current flowing through the stator coil is zero, and the torque output increases with an increase in the slip frequency S, that is, an increase in the difference between the electrical frequency [Hz] of the rotor caused by the rotation of the rotor and the electrical frequency [Hz] of the current flowing through the stator coil. When the slip frequency S is increased, the torque output becomes maximum at a certain slip frequency S. When the slip frequency S is further increased, the torque output decreases with an increase in the slip frequency S. The torque output increases with an increase in the current I flowing through the coil of the stator and decreases with a decrease in the current I.

The thick solid line E of FIG. 2 is the optimal efficiency line E connecting points of most efficient current I and slip frequency S for obtaining certain torque output when the induction motor generator 60 with the characteristics described above is driven. Therefore, when the operating point of the induction motor generator 60 is out over the optimal efficiency line E, the efficiency of the induction motor generator 60 decreases, and the power consumption for the same output increases. In normal control, the control unit 80 determines the current value I [A] supplied to the stator coil and the slip frequency S [Hz] along the optimal efficiency line E with respect to the required torque. The control unit 80 calculates an electrical frequency Fᵣ [Hz] of the rotor from the rotational speed of the rotor of the induction motor generator 60 detected by the resolver 61 and calculates an electrical frequency Fₛ [Hz] by adding the previously obtained slip frequency S [Hz] to the calculated electrical frequency Fᵣ [Hz] of the rotor. The control unit 80 operates the inverter 40 and supplies the AC current of the current I [A] at the electrical frequency Fₛ [Hz] to the coil of the stator of the induction motor generator 60 to generate torque and driving force according to the running state. As shown in FIG. 2, when a torque command T is T₁, the slip frequency S is S₁, and the current is the current I₂ of the characteristic curve of the broken line b, based on the optimal efficiency line E shown in FIG. 2. Therefore, the control unit 80 calculates the electrical frequency Fₛ [Hz] by adding the slip frequency S₁ [Hz] to the electrical frequency Fᵣ [Hz] of the rotor and operates the inverter 40 to supply the AC current of the current I₂ [A] at the electrical frequency Fₛ [Hz] to the stator coil of the induction motor generator 60.

The control unit 80 calculates the torque command Tₛ of the synchronous motor generator 50 based on the running data of the electric vehicle 100 and acquires the waveform and the voltage of the three-phase AC power to be supplied to the stator of the synchronous motor generator 50 from the control map based on the calculated output torque command Tₛ of the synchronous motor generator 50. The control unit 80 operates the inverter 30 and the boost converter 20 and supplies, to the synchronous motor generator 50, the three-phase AC power with the waveform and the voltage to generate torque and driving force according to the running state.

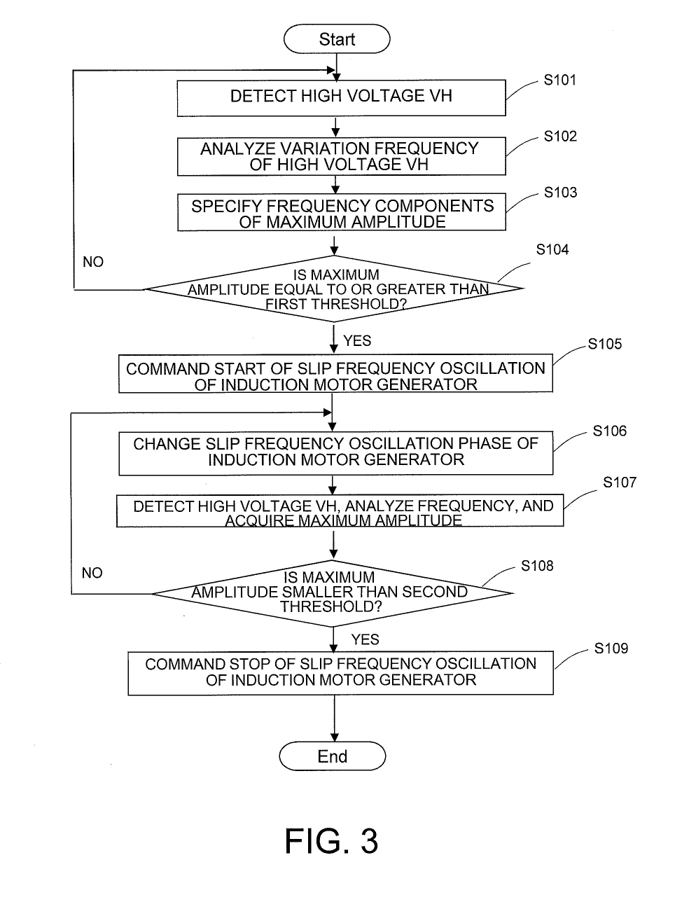

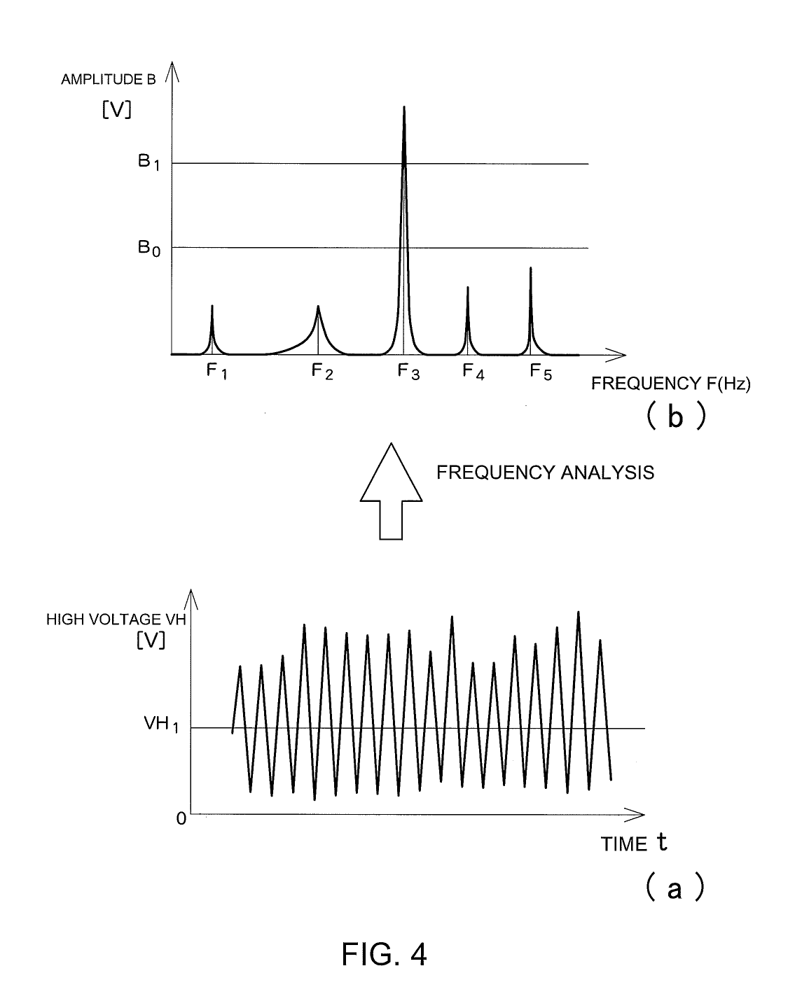

Operation of the electric vehicle 100 will be described with reference to FIGS. 3 to 5E. As described, when the number of oscillations of the counter-electromotive force from the synchronous motor generator 50 is close to the LC resonance frequency determined by the electrostatic capacitance (C) of the smoothing capacitor 23 and the reactance (L) of the coil 12 of the boost converter 20, the LC resonance in the circuit of the PCU 90 may be excited, and the high voltage VH may be significantly oscillated as indicated by a lower graph (a) of FIG. 4. When the detection error of the current sensors 52 and 53 of the synchronous motor generator 50 or the detection error of the resolver 51 is greater than a predetermined value, the control stability of the torque and the rotational speed may be reduced. The oscillation of the counter-electromotive voltage of the synchronous motor generator 50 may excite the voltage oscillation in the circuit of the PCU 90, and the high voltage VH may be significantly oscillated as indicated by the lower graph (a) of FIG. 4.

Therefore, the control unit 80 executes the first program in the voltage oscillation reduction programs 87 shown in FIG. 1. As shown in step S101 of FIG. 3, the control unit 80 detects the high voltage VH through the high-voltage sensor 73 when the electric vehicle 100 is running. As shown in step S102 of FIG. 3, the control unit 80 performs variation frequency analysis of the high voltage VH to obtain oscillation frequencies F₁ to F₅ [Hz] and distribution of amplitude B [V] at the oscillation frequencies F₁ to F₅ [Hz] as indicated by an upper graph (b) of FIG. 4. The frequency analysis may be performed by a general method, such as FFT, for example. As shown in step S103 of FIG. 3, the control unit 80 specifies frequency components with the maximum amplitude B and determines whether the amplitude B exceeds a first threshold B₁ as shown in step S104 of FIG. 3. In the present embodiment, the frequency with the maximum amplitude B is the frequency F₃ [Hz] as indicated by the lower graph (a) of FIG. 4, and the amplitude exceeds the first threshold B₁. Therefore, the control unit 80 proceeds to step S105 of FIG. 3 to start the oscillation of the slip frequency S of the induction motor generator 60.

The slip frequency S of the induction motor generator 60 is oscillated by periodically moving the operating point of the induction motor generator 60 close to and away from the optimal efficiency line E shown in FIG. 2, while the constant state of the torque output of the induction motor generator 60 is held. More specifically, the operating point is moved back and forth in the horizontal direction between points P₁ and P₄ on FIG. 2.

Now, as shown in FIG. 2, the induction motor generator 60 is operated at the point P₁ on the optimal efficiency line E with the torque output T₁, the slip frequency S₁, and the current I₂. From the result of the frequency analysis, the frequency of the voltage oscillation to be reduced is the frequency F₃ [Hz] shown in the upper graph (b) of FIG. 4, and the control unit 80 increases and decreases a slip frequency command S* between S₁ and S₄ (between the point P₁ and the point P₄) at the frequency F₃ [Hz] or at a period 1/F₃ [sec] to make the torque output (torque command T*) of the induction motor generator 60 constant. The torque output of the induction motor generator 60 is made constant to suppress the generation of the vehicle oscillation in the electric vehicle 100. Since the induction motor generator 60 is operated at the point P₁ on the optimal efficiency line E, the torque output (torque command T*) can be made constant, and the slip frequency command S* can be changed to increase the power consumption of the induction motor generator 60. However, it is difficult to reduce the power consumption of the induction motor generator 60 below the power consumption at the point P₁.

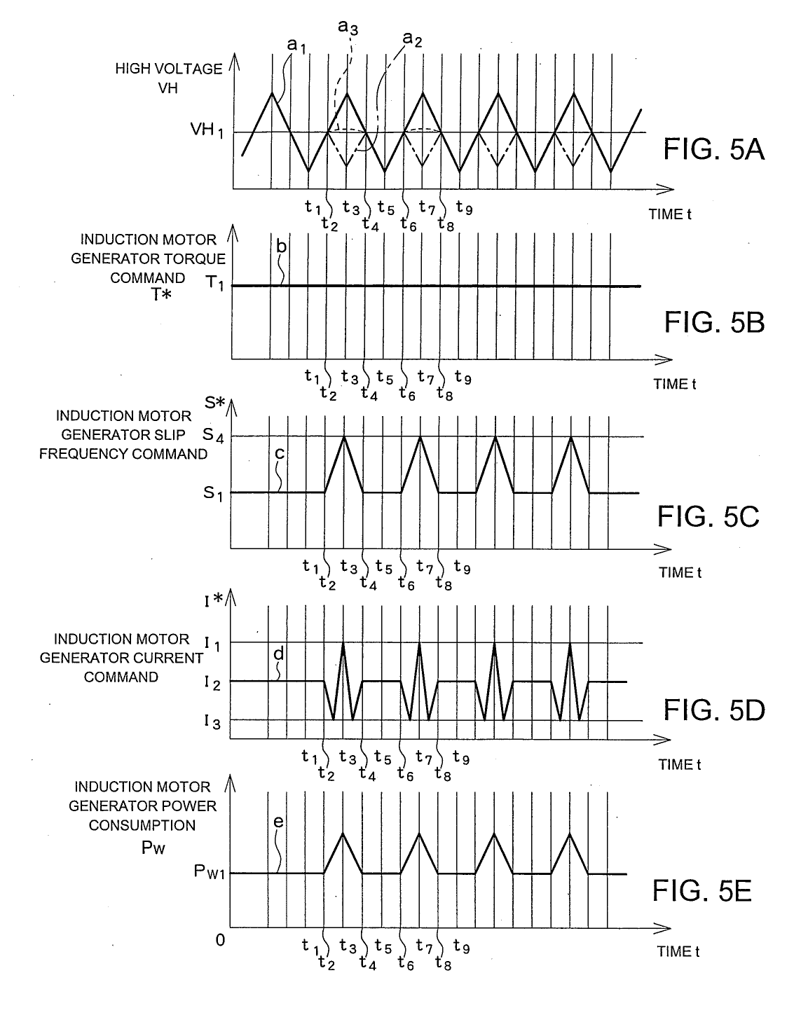

As indicated by a line a₁ of FIG. 5A, the high voltage VH is oscillated at the frequency F₃ [Hz], and the period between time t₁ and time t₅ of FIG. 5A is 1/F₃ [sec]. Therefore, the slip frequency command S* can be oscillated to move the operating point of the induction motor generator 60 back and forth between the point P₁ and the point P₄ between the time t₁ and the time t₅ shown in FIG. 5A, and the power consumption of the induction motor generator 60 can be oscillated to thereby reduce the peak of the high voltage VH. However, in a time zone in which the high voltage VH is lower than a set voltage VH₁, such as between times t₄ and t₆ shown in FIG. 5A, for example, the increase in the power consumption of the induction motor generator 60 by moving the operating point of the induction motor generator 60 to a point other than P₁ promotes the tendency that the high voltage VH becomes smaller than the set voltage VH₁. Therefore, the slip frequency command S* needs to be constant and kept at the original S₁ in this period to allow the induction motor generator 60 to operate at the point P₁ shown in FIG. 2. Therefore, the slip frequency command S* needs to have a waveform such that the slip frequency command S* is moved back and forth between S₁ and S₄ in a time period of ½ of the period 1/F₃ [sec], the slip frequency command S* is constant at S₁ in the remaining time period of ½ of the period 1/F₃ [sec], and the period of S₄ at the peak is the period 1/F₃ [sec]. For example, as indicated by a line c of FIG. 5C, the slip frequency command S* is moved back and forth between S₁ and S₄ between the time t₂ and the time t₄ (time period of ½ of the period 1/F₃ [sec]), the slip frequency command S* is constant at S₁ between the time t₄ and the time t₆ (time period of ½ of the period 1/F₃ [sec]), and the time from S₄ at the peak of the slip frequency command S* to the next peak S₄ is from the time t₃ to time t₇ (period 1/F₃ [sec]) that is from a peak to a peak of the high voltage VH in the waveform (waveform like the line c shown in FIG. 5C).

When the torque output (torque command T*) of the induction motor generator 60 is made constant to increase the slip frequency command S* from S₁ to S₄ such as between the time t₂ and the time t₃, the control unit 80 first moves the operating point of the induction motor generator 60 from P₁ to P₂ shown in FIG. 2. In this case, the current needs to be reduced from I₂ at the point P₁ to I₃ at the point P₂. When the operating point of the induction motor generator 60 is moved from P₂ to P₃ shown in FIG. 2, the current needs to be increased from I₃ at the point P₂ to I₂ at the point P₃. When the operating point of the induction motor generator 60 is moved from P₃ to P₄ shown in FIG. 2, the current needs to be increased from I₂ at the point P₃ to I₁ (maximum current) at the point P₁. Therefore, when the slip frequency command S* is increased from S₁ to S₄ such as between the time t₂ and the time t₃ as in the line c shown in FIG. 5C, the current command I* of the induction motor generator 60 indicates a command waveform that temporarily decreases from I₂ to I₃ and then increases to I₁ at the peak between the time t₂ and the time t₃ as indicated by a line d of FIG. 5D. Conversely, when the slip frequency command S* is reduced from S₄ to S₁, the command waveform decreases from I₁ at the peak to I₃ and then returns to the original I₂ as indicated by the line d of FIG. 5D.

When the slip frequency command S* and the current command I* of the induction motor generator 60 are changed based on the waveform described above, the torque output of the induction motor generator 60 remains constant at T₁ as indicated by a line b of FIG. 5B, and power consumption P_{w} of the induction motor generator 60 increases from the original P_{w1} between the time t₂ and the time t₄ (time of ½ of the period 1/F₃ [sec]) as indicated by a line E of FIG. 5E to reduce the high voltage VH. The original P_{w1} is held between the time t₄ and the time t₆ (time of ½ of the period 1/F₃ [sec]), and the peak interval of the power consumption (time interval for reducing the high voltage VH) is between the time t₃ and the time t₇ (period 1/F₃ [sec]).

As described, the control unit 80 makes the torque output (torque command T*) of the induction motor generator 60 constant to generate a waveform of the slip frequency command S* and the current command I* of the induction motor generator 60 that oscillates at the frequency F₃ [Hz] (period 1/F₃ [sec]).

As shown in step S106 of FIG. 3, the control unit 80 changes the phases of the generated command waveforms so that the peak of the power consumption P_{w} of the induction motor generator 60 coincides with the peak of the high voltage VH. The phases may be adjusted by shifting the phases of the AC current waveforms supplied from the inverter 40 to the induction motor generator 60. When the peak of the power consumption P_{w} of the induction motor generator 60 coincides with the peak of the high voltage VH, the peak voltage of the high voltage VH is reduced as indicated by an alternate long and short dash line a₂ of FIG. 5A. More specifically, the oscillation of the power consumption P_{w} of the induction motor generator 60 generates voltage oscillation in the phase just opposite the oscillation of the high voltage VH, and the voltage oscillation in the opposite phase reduces the peak of the high voltage VH at the time t₃, the time t₇, and the like as indicated by a broken line a₃ of FIG. 5A.

As shown in step S107 of FIG. 3, the control unit 80 detects the high voltage VH and analyzes the frequency to acquire the maximum amplitude. As shown in step S108 of FIG. 3, the control unit 80 determines whether the maximum amplitude is smaller than a second threshold B₀ indicated by the upper graph (b) of FIG. 4. If the maximum amplitude is smaller than the second threshold B₀, the control unit 80 determines that the oscillation of the high voltage VH is converged. As shown in step S109 of FIG. 3, the control unit 80 stops the oscillation of the slip frequency S of the induction motor generator 60 and returns to the normal control (end of the first program of the voltage oscillation reduction programs 87).

In this way, according to the present embodiment, the voltage oscillation in the PCU 90 can be reduced, and the peak of the high voltage VH can be reduced. This can suppress the reduction in the lifetime of the electrical elements, such as switching elements and diodes, in the PCU 90 caused by high voltage. In the conventional technique, the high voltage VH needs to be increased greater than the optimal operation voltage to avoid the oscillation of the high voltage VH caused by LC resonance. However, according to the present embodiment, the high voltage VH can be controlled and maintained at the optimal voltage even in an area with LC resonance, and the boosting loss can be suppressed. Therefore, it is an advantage that the fuel efficiency can be improved.

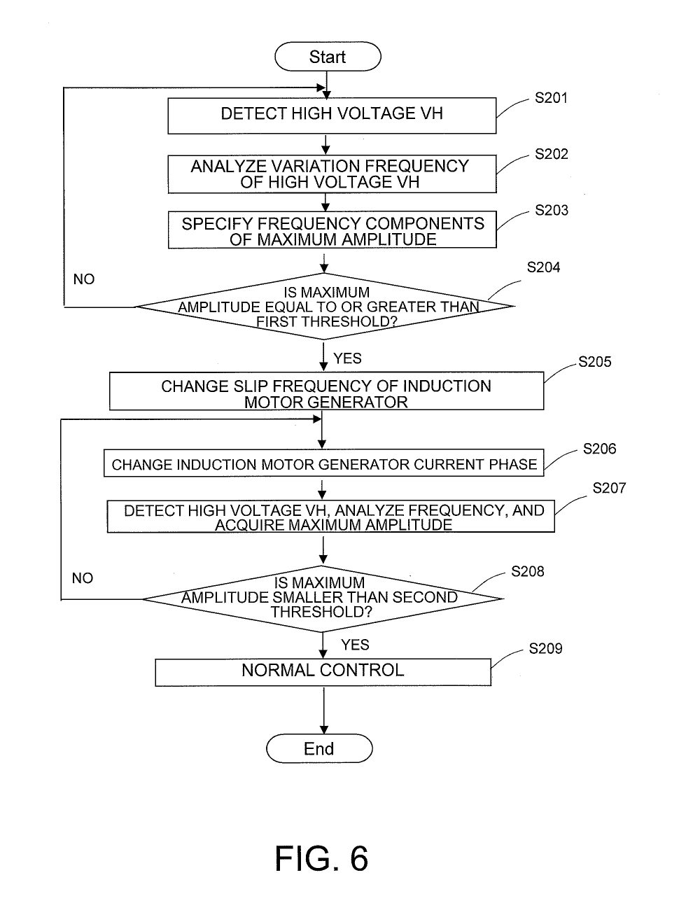

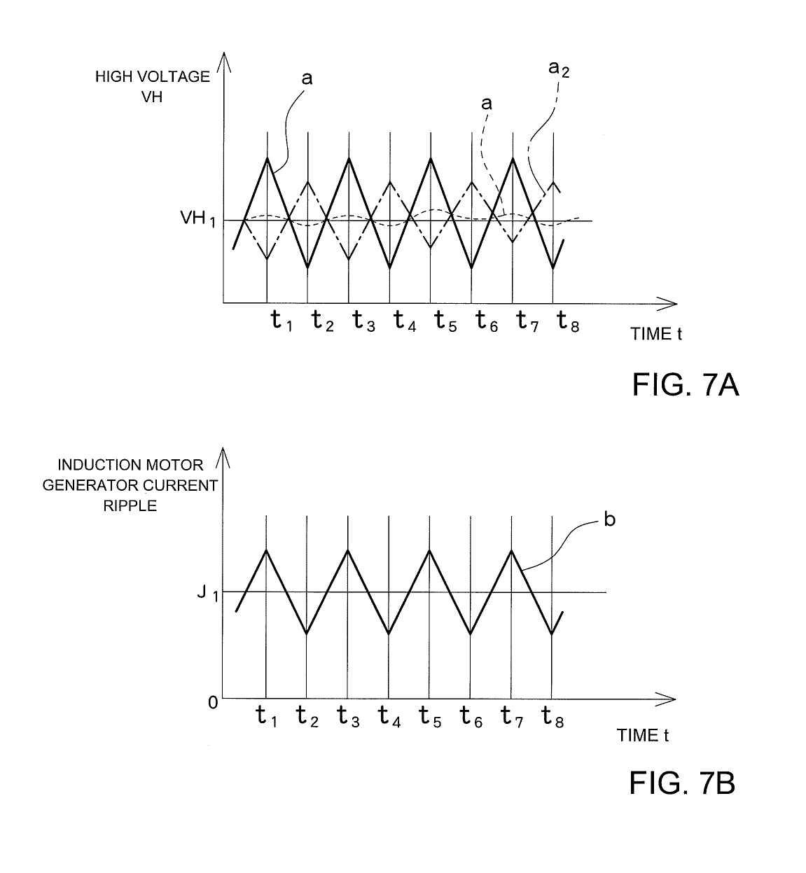

Another embodiment of the present invention will be described with reference to FIGS. 6, 7A, and 7B. The same parts as the parts described with reference to FIGS. 1 to 5E will not be described. In the present embodiment, when the oscillation of the high voltage VH is generated, the slip frequency S of the AC power supplied to the induction motor generator 60 is changed, the frequency of a current ripple generated in the induction motor generator 60 is the same as the frequency of the high voltage VH, and the oscillation of the high voltage VH is canceled by the voltage oscillation generated by the current ripple.

The control unit 80 executes the second program in the voltage oscillation reduction programs 87 shown in FIG. 1. As described in steps S101 to S104 of FIG. 3, the control unit 80 detects the high voltage VH through the high-voltage sensor 73 as indicated by the lower graph (a) of FIG. 4, performs the variation frequency analysis of the high voltage VH, specifies the frequency of the maximum amplitude, and determines whether the maximum amplitude at the frequency is equal to or greater than the first threshold B₁ of the upper graph (b) of FIG. 4 in steps S201 to S204 of FIG. 6. If the maximum amplitude is equal to or greater than the first threshold B₁, the control unit 80 changes the slip frequency S of the induction motor generator 60 as shown in step S205 of FIG. 6.

In the induction motor generator 60, a torque ripple is generated by the rotation of the rotor, and as a result, a current ripple is generated. The frequency of the current ripple is determined by the electrical frequency of the AC current supplied to the induction motor generator 60 and the number of poles of the rotor and the stator, and the frequency is an integral multiple of the electrical frequency of the AC current supplied to the induction motor generator 60. For example, when the electrical frequency of the AC current supplied to the induction motor generator is F_{A}, the frequency of the current ripple generated in the induction motor generator 60 is N×F_{A} (Nth-order electrical frequency, for example, N=6 in the case of sixth-order electrical frequency). When the oscillation frequency of the high voltage VH equal to or greater than the first threshold B₁ is F₃ as indicated by the upper graph (b) of FIG. 4, the frequency of the current ripple of the induction motor generator 60 can be N×F_{A}=F₃ to bring the frequency of the current ripple generated in the induction motor generator 60 into line with the frequency of the high voltage VH. Since the difference between the rotational speed (electrical frequency) Fᵣ of the rotor of the induction motor generator 60 and the electrical frequency F_{A} of the AC power supplied to the stator of the induction motor generator 60 is the slip frequency S, the following holds true.

S=F_{A}−Fᵣ (Expression 1)

As described, F_{A}=F₃/N holds true when the number of oscillations of the high voltage VH is F₃, and this can be assigned to Expression 1 to obtain the following formula.

S=F₃/N−Fᵣ (Expression 2)

Therefore, if the slip frequency command S* of the AC power supplied to the stator of the induction motor generator 60 is changed to the slip frequency S calculated by Expression 2 when the electrical frequency of the rotor of the induction motor generator 60 detected by the resolver 61 is Fᵣ, the number of oscillations (F₃) or period of the current oscillation of the high voltage VH indicated by a line a₁ shown in FIG. 7A coincides with the number of oscillations (N×F_{A}) or period of the current ripple generated in the induction motor generator 60 indicated by a line b in FIG. 7B.

To change the slip frequency command S*, the current command I is changed according to the characteristic curves described with reference to FIG. 2 to make the output torque of the induction motor generator 60 constant to prevent the generation of the vehicle oscillation in the electric vehicle 100.

As shown in step S206 of FIG. 6, the control unit 80 changes the phase of the AC current supplied to the stator of the induction motor generator 60. For example, as shown in FIGS. 7A and 7B, the phase of the AC power supplied to the stator is changed so that the peak of the high voltage VH at the time t₁ coincides with the peak of the ripple current generated in the induction motor generator 60. When the peak of the high voltage VH coincides with the peak of the ripple current generated in the induction motor generator 60, the oscillation of the ripple current generated in the induction motor generator 60 generates voltage oscillation in the phase opposite to the oscillation of the high voltage VH as indicated by an alternate long and short dash line a₂ of FIG. 7A, and the voltage oscillation in the opposite phase reduces the oscillation of the high voltage VH as indicated by a broken line a₃ of FIG. 7A.

As shown in step S207 of FIG. 6, the control unit 80 detects the high voltage VH and analyzes the frequency to acquire the maximum amplitude. As shown in step S208 of FIG. 6, if the maximum amplitude is smaller than the second threshold B₀ indicated by the upper graph (b) of FIG. 4, the control unit 80 determines that the oscillation of the high voltage VH is converged and returns to the normal control as shown in step S209 of FIG. 6.

On the other hand, when the maximum amplitude is smaller than the second threshold B₀ after the change in the phase of the AC current supplied to the stator of the induction motor generator 60, the control unit 80 returns to step S206 of FIG. 6 to increase or decrease the amount of change in the phase of the AC current to make the maximum amplitude smaller than the second threshold B₀.

In the synchronous motor generator 50, the rotational speed (electrical frequency) of the AC power supplied to the stator coil is synchronous with the rotational speed (electrical frequency) of the rotor. Therefore, torque variation is generated at a frequency of an integral multiple of the frequency of the AC power supplied to the stator coil according to the number of poles of the rotor and the stator, and the variation in the counter-electromotive voltage caused by the torque variation excites the oscillation of the high voltage VH in many cases. Thus, the phase of the AC current supplied to the induction motor generator 60 may be changed relative to the phase of the AC current supplied to the synchronous motor generator 50 to, for example, change the phase to the direction of the same phase or change the phase to the direction of the opposite phase to make an adjustment so that the oscillation of the high voltage VH and the voltage oscillation generated by the current ripple of the induction motor generator 60 are in opposite phases.

As described, when the maximum amplitude is smaller than the second threshold B₀, the control unit 80 determines that the oscillation of the high voltage VH is converged and returns to the normal control as shown in step S209 of FIG. 6 (end of second program of the voltage oscillation reduction programs 87).

As in the embodiment described above, the peak of the high voltage VH can be reduced by reducing the voltage oscillation in the PCU 90 in the present embodiment. Therefore, the reduction in the lifetime of the electrical elements, such as switching elements and diodes, in the PCU 90 caused by the high voltage can be suppressed. Even in an area with LC resonance, boosting for avoiding the LC resonance is not necessary, and the generation of boosting loss can be suppressed. There is an advantage that the fuel efficiency can be improved.

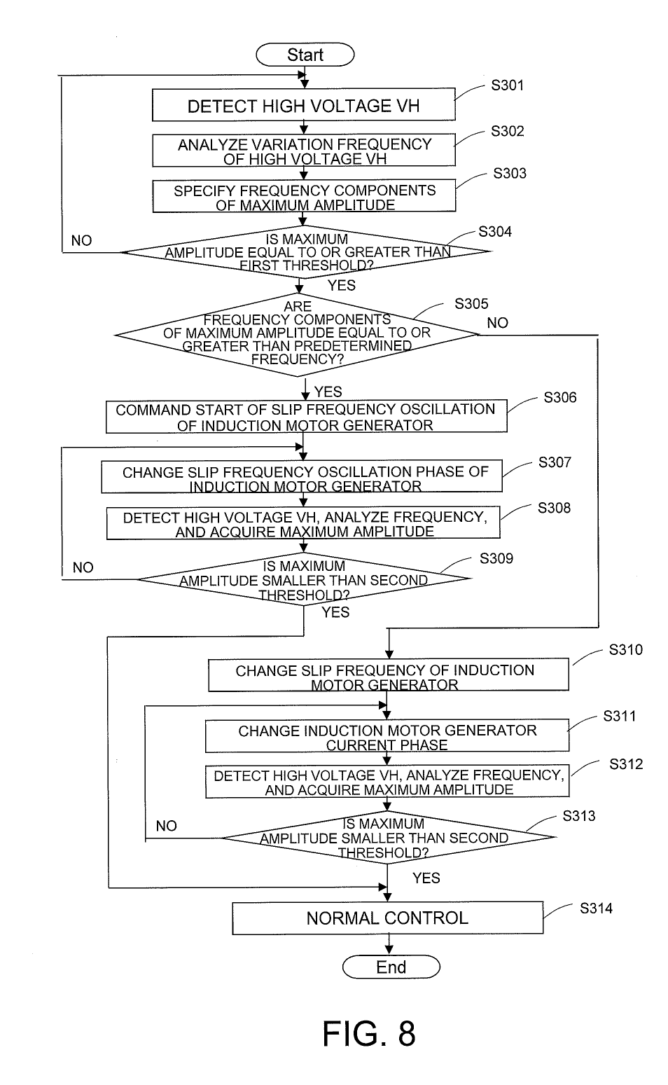

Another embodiment of the present invention will be described with reference to FIG. 8. In the above-described method of oscillating the slip frequency S of the AC current supplied to the induction motor generator 60 to reduce the peak voltage of the high voltage VH (first program in the voltage oscillation reduction programs 87), the slip frequency S is oscillated to make the torque output constant to suppress the generation of oscillation in the electric vehicle. However, the torque output may not be constant in the transition time. Particularly, when the slip frequency S is oscillated at a low frequency, the variation of the torque output in the transition time may lead to vehicle oscillation of the electric vehicle 100. On the other hand, oscillation of the slip frequency S at a high frequency does not lead to variation in the actual torque that generates vehicle oscillation, even if the torque output is not constant due to the moment of inertia of the rotation drive section or the like. Therefore, the first program in the voltage oscillation reduction programs 87 can more effectively suppress the oscillation or the voltage peak of the high voltage VH while suppressing the vehicle oscillation when the oscillation of the high voltage VH is generated in a high frequency area.

Meanwhile, in the above-described method of changing the frequency of the slip frequency of the AC current supplied to the induction motor generator 60 to bring the number of oscillations of the current ripple of the induction motor generator 60 into line with the voltage oscillation of the high voltage VH to generate the voltage oscillation in the phase opposite to the high voltage VH to reduce the oscillation of the high voltage VH (second program in the voltage oscillation reduction programs 87), the slip frequency command S* needs to be the slip frequency S calculated by Expression 2 described above (described again below).

S=F₃/N−Fᵣ (Expression 2)

In the induction motor generator 60, when the slip frequency S is increased from S₁ to S₄ to move the operating point of the induction motor generator 60 from the initial point P₁ to the point P₄ as shown in FIG. 2, the current can be changed to move the operating point to make the torque output constant. That is, the operating point can be moved in the horizontal direction in FIG. 2. However, when the number of oscillations F₃ of the high voltage VH increases, the slip frequency S calculated by Expression 2 needs to be equal to or greater than S₄. When the slip frequency S is equal to or greater than S₄, the output torque of the induction motor generator 60 decreases along the line a that is a characteristic in the case of the maximum current I₁, and the torque output decreases to T₄ when the slip frequency S is S₅. Therefore, the power necessary for the electric vehicle 100 to run may be insufficient. Thus, the second program in the voltage oscillation reduction programs 87 can more effectively reduce the oscillation of the high voltage VH in a low-frequency area, in which the oscillation frequency F₃ of the high voltage VH is low, and the slip frequency S does not have to be increased to S₄ or more.

Therefore, the third program in the voltage oscillation reduction programs 87 reduces the voltage oscillation of the high voltage VH by carrying out the first program in the voltage oscillation reduction programs 87 when the number of oscillations F₃ of the maximum amplitude of the high voltage VH is high and reduces the voltage oscillation of the high voltage VH by carrying out the second program in the voltage oscillation reduction programs 87 when the number of oscillations F₃ of the maximum amplitude of the high voltage VH is low. This will be described with reference to FIG. 8.

As shown in steps S301 to S304 of FIG. 8, the control unit 80 detects the high voltage VH and analyzes the variation frequency. The control unit 80 then specifies the frequency components of the maximum amplitude and determines whether the maximum amplitude is equal to or greater than the first threshold B₁ indicated by the upper graph (b) of FIG. 4. If the maximum amplitude is equal to or greater than the first threshold B₁, the control unit 80 determines whether the frequency components of the maximum amplitude are equal to or greater than a predetermined frequency as shown in step S305 of FIG. 8. The predetermined frequency Fₘₐₓ may be a value determined by the integer N determined from the rotational electrical frequency Fᵣ and the number of poles of the rotor of the induction motor generator 60 when S=S₄ (maximum slip frequency with constant torque output) in Expression 2.

Fₘₐₓ=N×Fᵣ+S₄) (Expression 3)

Here, N is a multiple of the rotational electrical frequency Fᵣ of the rotor of the induction motor generator 60 at the frequency of the current ripple generated in the induction motor generator 60 or is an order of the electrical frequency.

If the frequency components of the maximum amplitude are equal to or greater than the predetermined frequency Fₘₐₓ, the control unit 80 executes the first program in the voltage oscillation reduction programs 87 as shown in steps S306 to S309 of FIG. 8. The actual control operation of steps S306 to S309 of FIG. 8 is the same as steps S105 to S108 of FIG. 3. If the frequency components of the maximum amplitude are not equal to or greater than the predetermined frequency Fₘₐₓ (smaller than Fₘₐₓ), the control unit 80 executes the second program in the voltage oscillation reduction programs 87 as shown in steps S310 to S313 of FIG. 8. The actual control operation of steps S310 to S313 of FIG. 8 is the same as steps S205 to S208 of FIG. 6.

As described, in addition to the advantages of the two embodiments described above, the third program in the voltage oscillation reduction programs 87 of the present embodiment reduces the voltage oscillation of the high voltage VH by carrying out the first program in the voltage oscillation reduction programs 87 when the number of oscillations of the maximum amplitude of the high voltage VH is high and carrying out the second program in the voltage oscillation reduction programs 87 when the number of oscillations of the maximum amplitude of the high voltage VH is low, and the third program has an advantage that a wide range of the number of oscillations of the high voltage VH can be handled.

In the embodiments described above, the voltage oscillation synchronous with the oscillation of the high voltage VH is generated to reduce the voltage oscillation of the high voltage VH. However, instead of generating the electrical oscillation at a specific frequency as in the embodiments described above, the high voltage VH detected by the high-voltage sensor 73 may be fed back to change the slip frequency S of the induction motor generator 60 to reduce the peak of the high voltage VH.

In the control unit 80, a changing map of the slip frequency setting value relative to the deviation from the setting value VH₁ of the high voltage VH as shown in FIG. 9 is stored in the voltage oscillation reduction programs 87. In the map, the slip frequency S increases if the high voltage VH exceeds the setting value VH₁ at the constant S₁ shown in FIG. 2 when the value of the high voltage VH is equal to or smaller than the setting value VH₁, and the slip frequency S is the maximum slip frequency S₄ (see FIG. 2) that allows control of constant torque output, at the peak VH₃ of the oscillation of the high voltage VH. When the high voltage VH detected by the high-voltage sensor 73 exceeds the setting value VH₁, the control unit 80 increases the slip frequency S of the induction motor generator 60 according to the map shown in FIG. 9 and increases the power consumption of the induction motor generator 60 to reduce the high voltage VH while maintaining the constant torque output. The present embodiment attains the same advantage as the advantage when the first program in the voltage oscillation reduction programs 87 described above is carried out.

In the embodiments described above, the boost converter 20 boosts the low voltage VL of the battery 10 to the high voltage VH and supplies the high voltage VH to the inverters 30 and 40. However, when the boost converter 20 is not included, the low-voltage sensor 72 may be used in place of the high-voltage sensor 73 to detect the low voltage VL to suppress the oscillation of the low voltage VL. The output of the voltage sensor 71 that detects the voltage of the battery 10 may be used in place of the low-voltage sensor 72.

Although one synchronous motor generator 50 and one induction motor generator 60 are included in the present embodiments described above, the electric vehicle 100 may include a plurality of synchronous motor generators 50 and a plurality of induction motor generators 60. For example, the present invention can also be applied to an electric vehicle 100 including a synchronous motor generator 50 and an induction motor generator 60 that drive the front wheel 57 and including another synchronous motor generator 50 and another induction motor generator 60 that drive the rear wheel 67. In this way, in the electric vehicle 100 including a plurality of induction motor generators 60, the slip frequency S of one or a plurality of induction motor generators 60 among the plurality of induction motor generators 60 may be oscillated or changed.

The present invention is not limited to the embodiments described above, and the present invention includes all changes and modifications without departing from the technical scope and the spirit of the present invention defined by the claims.

1. An electric vehicle comprising:
at least one induction motor for driving a vehicle;
at least one other motor for driving a vehicle;
at least one inverter that supplies at least one AC voltage to the at least one induction motor for driving a vehicle;
at least one other inverter that supplies at least one other AC voltage to the at least one other motor for driving a vehicle; and
a control unit that adjusts respective rotational speed and respective torque output of each of the at least one induction motor for driving a vehicle and the at least one other motor for driving a vehicle, wherein
the control unit
comprises voltage oscillation reduction means for causing the at least one induction motor for driving a vehicle to generate voltage oscillation in a phase opposite to voltage oscillation of DC voltage to reduce the voltage oscillation of the DC voltage when the DC voltage supplied to the inverters oscillates at an amplitude equal to or greater than a predetermined voltage value due to rotation of the at least one other motor for driving a vehicle.

2. The electric vehicle according to claim 1, wherein
the voltage oscillation reduction means
are first means for oscillating a slip frequency of the at least one induction motor for driving a vehicle at a frequency of the voltage oscillation of the DC voltage to generate the voltage oscillation in the phase opposite to the voltage oscillation of the DC voltage.

3. The electric vehicle according to claim 2, wherein
the first means
oscillate the slip frequency while maintaining the torque output of the at least one induction motor for driving a vehicle.

4. The electric vehicle according to claim 1, wherein
the voltage oscillation reduction means
are second means for supplying, to the at least one induction motor for driving a vehicle, an AC current that causes a current ripple of the at least one induction motor for driving a vehicle to generate the voltage of the phase opposite to the voltage oscillation of the DC voltage at the frequency of the voltage oscillation of the DC voltage.

5. The electric vehicle according to claim 4, wherein
the second means
change the slip frequency of the at least one induction motor for driving a vehicle to bring the current ripple of the at least one induction motor for driving a vehicle into line with the frequency of the voltage oscillation of the DC voltage and
change the phase of the AC current to bring the phase of the voltage oscillation generated by the current ripple of the at least one induction motor for driving a vehicle into line with the phase opposite to the voltage oscillation of the DC voltage.

6. The electric vehicle according to claim 5, wherein
the second means
change the slip frequency while maintaining the torque output of the at least one induction motor for driving a vehicle.

7. The electric vehicle according to claim 1, wherein
the voltage oscillation reduction means comprise:
first means for oscillating the slip frequency of the at least one induction motor for driving a vehicle at the frequency of the voltage oscillation of the DC voltage to generate the voltage oscillation in the phase opposite to the voltage oscillation of the DC voltage; and
second means for supplying, to the at least one induction motor for driving a vehicle, an AC current that causes the current ripple of the at least one induction motor for driving a vehicle to generate the voltage of the phase opposite to the voltage oscillation of the DC voltage at the frequency of the voltage oscillation of the DC voltage,
cause the first means to reduce the voltage oscillation of the DC voltage if the frequency of the voltage oscillation of the DC voltage is equal to or greater than a predetermined frequency, and cause the second means to reduce the voltage oscillation of the DC voltage if the frequency of the voltage oscillation of the DC voltage is smaller than the predetermined frequency.

8. The electric vehicle according to claim 7, wherein
the first means
oscillate the slip frequency while maintaining the torque output of the at least one induction motor for driving a vehicle.

9. The electric vehicle according to claim 7, wherein
the second means
change the slip frequency of the at least one induction motor for driving a vehicle to bring the current ripple of the at least one induction motor for driving a vehicle into line with the frequency of the voltage oscillation of the DC voltage and
change the phase of the AC current to bring the phase of the voltage oscillation generated by the current ripple of the at least one induction motor for driving a vehicle into line with the phase opposite to the voltage oscillation of the DC voltage.

10. The electric vehicle according to claim 9, wherein
the second means
change the slip frequency while maintaining the torque output of the at least one induction motor for driving a vehicle.

11. The electric vehicle according to claim 1, further comprising
a voltage sensor that detects the DC voltage supplied to the inverters, wherein
the voltage oscillation reduction means
are third means for changing the slip frequency of the at least one induction motor for driving a vehicle while maintaining the torque output of the at least one induction motor for driving a vehicle according to the DC voltage detected by the voltage sensor.

12. An electric vehicle comprising:
at least one induction motor for driving a vehicle;
at least one other motor for driving a vehicle;
at least one inverter that supplies at least one AC voltage to the at least one induction motor for driving a vehicle;
at least one other inverter that supplies at least one other AC voltage to the at least one other motor for driving a vehicle; and
a control unit that comprises a CPU and that adjusts respective rotational speed and respective torque output of each of the at least one induction motor for driving a vehicle and the at least one other motor for driving a vehicle, wherein
the control unit causes the CPU to execute a voltage oscillation reduction program for causing the at least one induction motor for driving a vehicle to generate voltage oscillation in a phase opposite to voltage oscillation of DC voltage to reduce the voltage oscillation of the DC voltage when the DC voltage supplied to the inverters oscillates at an amplitude equal to or greater than a predetermined voltage value due to rotation of the at least one other motor for driving a vehicle.

13. A control method of an electric vehicle, the electric vehicle comprising:
at least one induction motor for driving a vehicle;
at least one other motor for driving a vehicle;
at least one inverter that supplies at least one AC voltage to the at least one induction motor for driving a vehicle;
at least one other inverter that supplies at least one other AC voltage to the at least one other motor for driving a vehicle; and
a control unit that adjusts respective rotational speed and respective torque output of each of the at least one induction motor for driving a vehicle and the at least one other motor for driving a vehicle,
the control method causing the at least one induction motor for driving a vehicle to generate voltage oscillation in a phase opposite to voltage oscillation of DC voltage to reduce the voltage oscillation of the DC voltage when the DC voltage supplied to the inverters oscillates at an amplitude equal to or greater than a predetermined voltage value due to rotation of the at least one other motor for driving a vehicle.
